(19) United States
(12) Patent Application Publication
(10) Pub. No.: US 2011/0144977 A1
(43) Pub. Date: Jun. 16, 2011

(54) WRITTEN EXPRESSION DEVELOPMENT SYSTEM

(75) Inventor: Toni Schulken, Charlotte, NC (US)

(73) Assignee: MeadWestvaco Corporation, Richmond, VA (US)

(21) Appl. No.: 13/059,338

(22) PCT Filed: Aug. 27, 2009
(86) PCT No.: PCT/US09/55125

§ 371 Date: Feb. 16, 2011

Related U.S. Application Data
(60) Provisional application No. 61/094,364, filed on Sep. 4, 2008.

(51) Int. Cl. G06F 17/27

(52) U.S. Cl. 704/9; 704/E19.001

(57) ABSTRACT

A system is disclosed for developing writing skills, and more particularly, developing written expression skills. The system may include various types of instruction sheets arranged in order of increasing complexity to aid the user in written expression and creative writing skill development.

### REFERENCE TO RELATED APPLICATION

This application claims the benefit of priority under 35 U.S.C. §119(e) of provisional application Ser. No. 61/094,364 filed on Sep. 4, 2008 which is hereby incorporated by reference in its entirety.

The present invention is directed to a system for developing writing skills, and more particularly, to a system for developing written expression skills.

### BACKGROUND

As children and other users begin to put their thoughts and ideas in written form, they may lack the basic skills to do so effectively. For example, children may lack the skills required to create and develop an organized, sequenced sentence or paragraph, or the knowledge of how to add details to their written work. Children may also not understand the basic concepts of utilizing visual imagery to add details to their written expression, utilizing visual imagery to sequence words and phrases, and utilizing a variety of words and phrases to describe their idea or story. Finally, children may lack skills required to arrange words and sentences in an organized manner. The present invention provides a system to aid a user in developing basic skills needed for early written expression and creative writing.

### BRIEF DESCRIPTION OF DRAWINGS

FIGS. 1 and 2 are examples of first, primary or basic instruction sheets;

FIGS. 3 and 4 are examples of second instruction sheets;

FIGS. 5 and 6 are examples of third instruction sheets;

FIGS. 7 and 8 are examples of fourth instruction sheets;

FIGS. 9 and 10 are examples of fifth instruction sheets;

FIGS. 11 and 12 are examples of sixth instruction sheets;

FIGS. 13 and 14 are examples of seventh instruction sheets; and

FIGS. 15 and 16 are examples of eighth instruction sheets.

### DETAILED DESCRIPTION

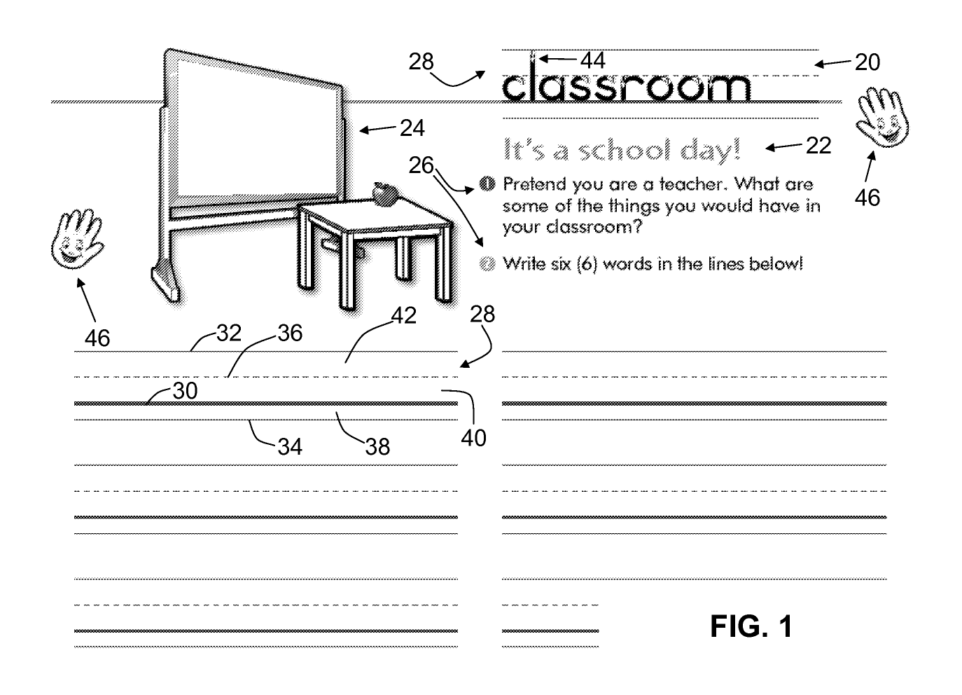

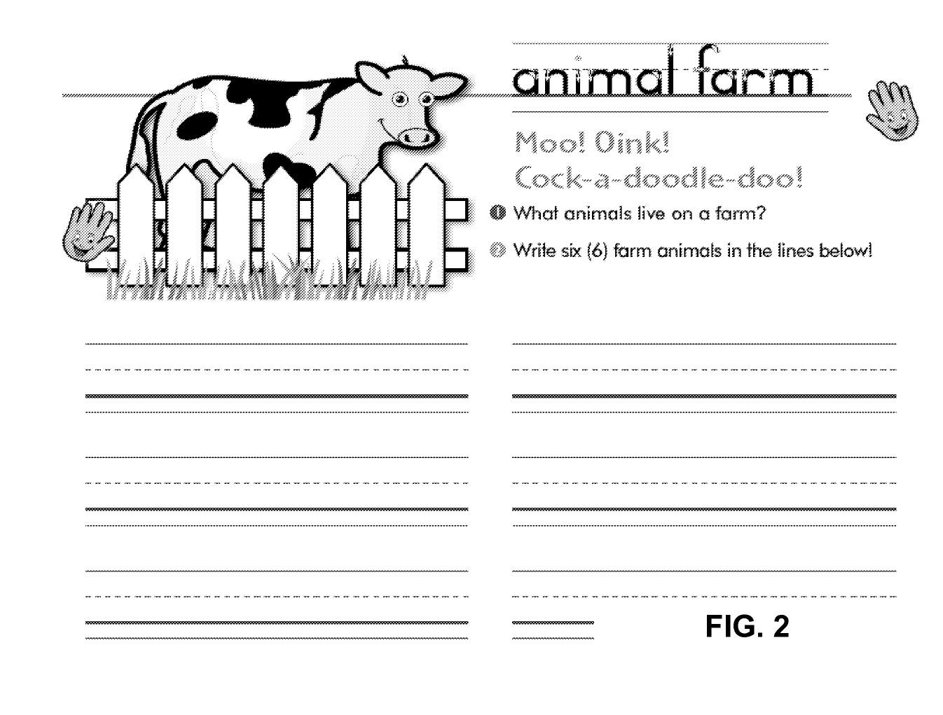

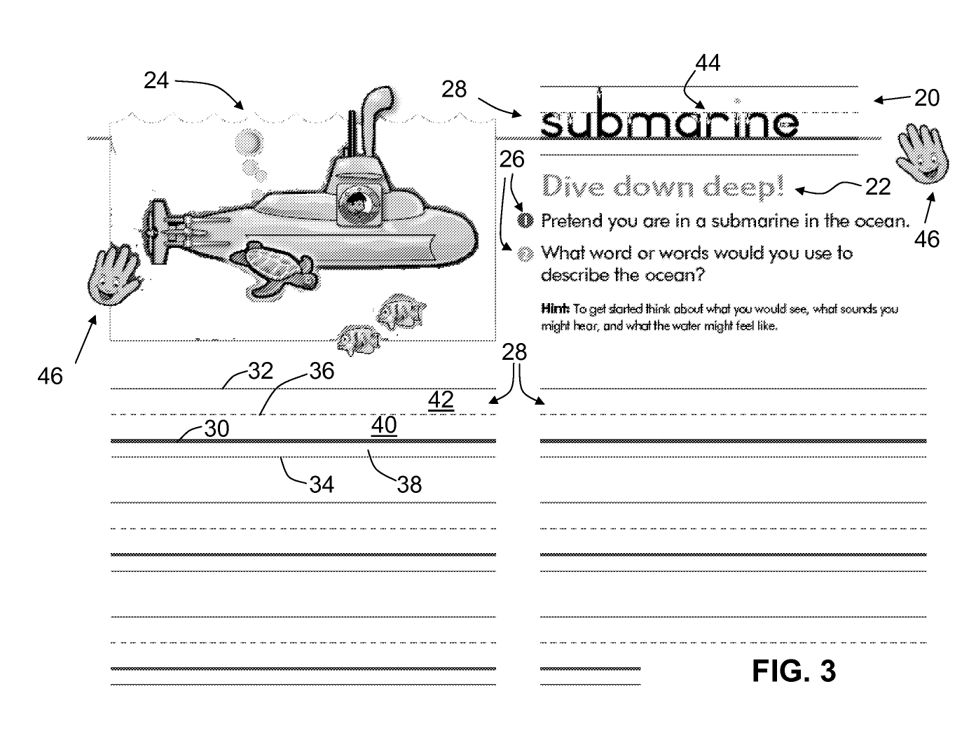

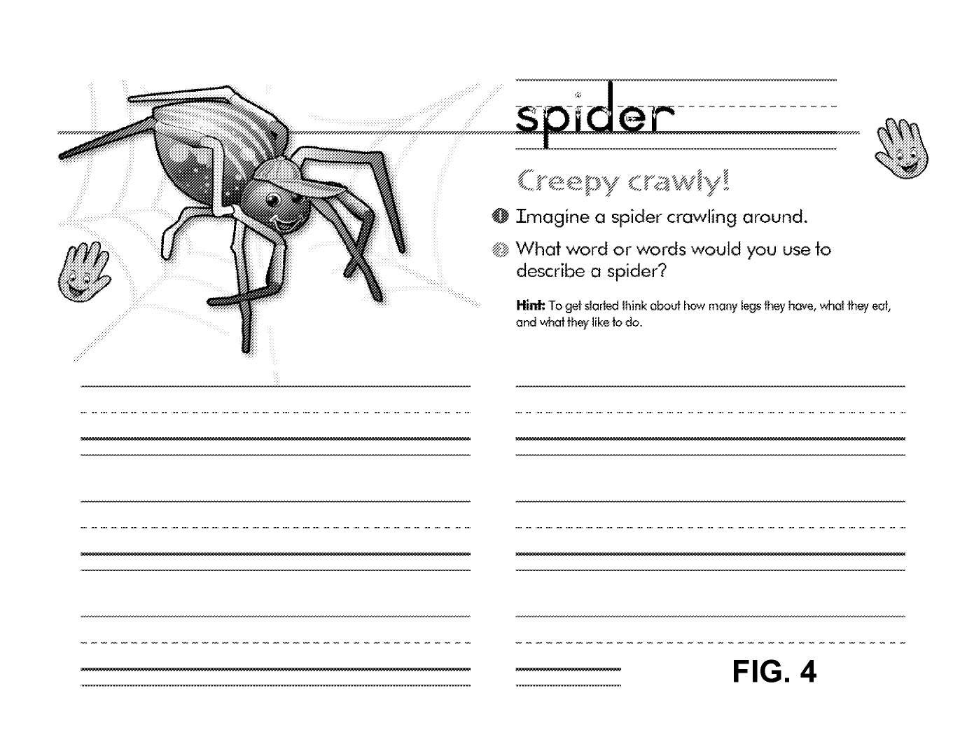

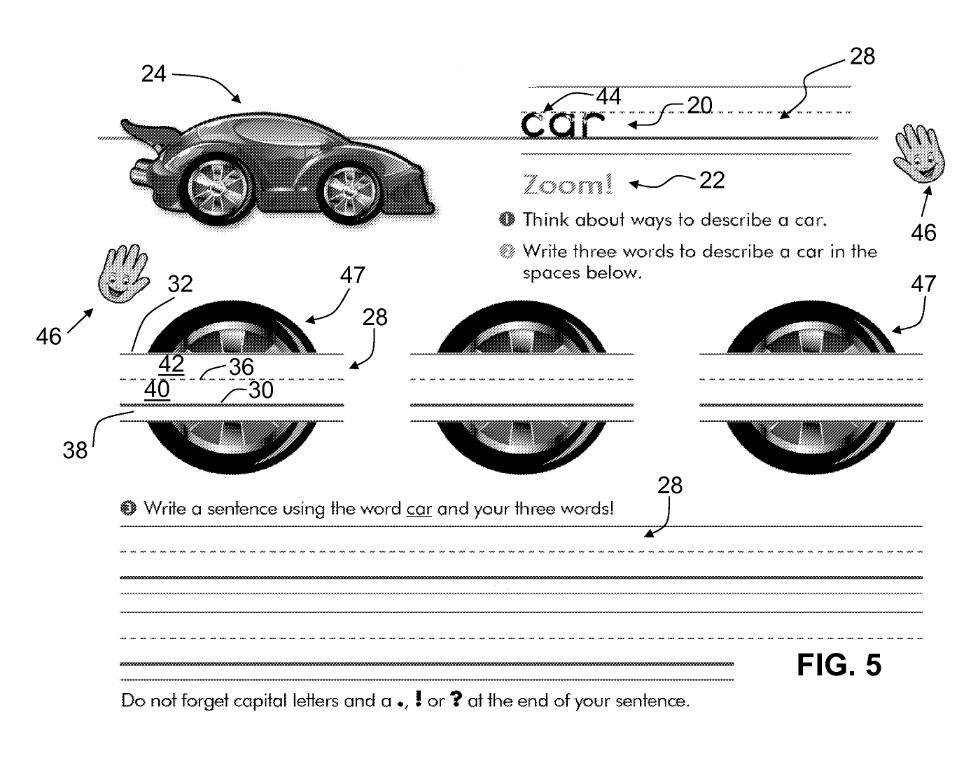

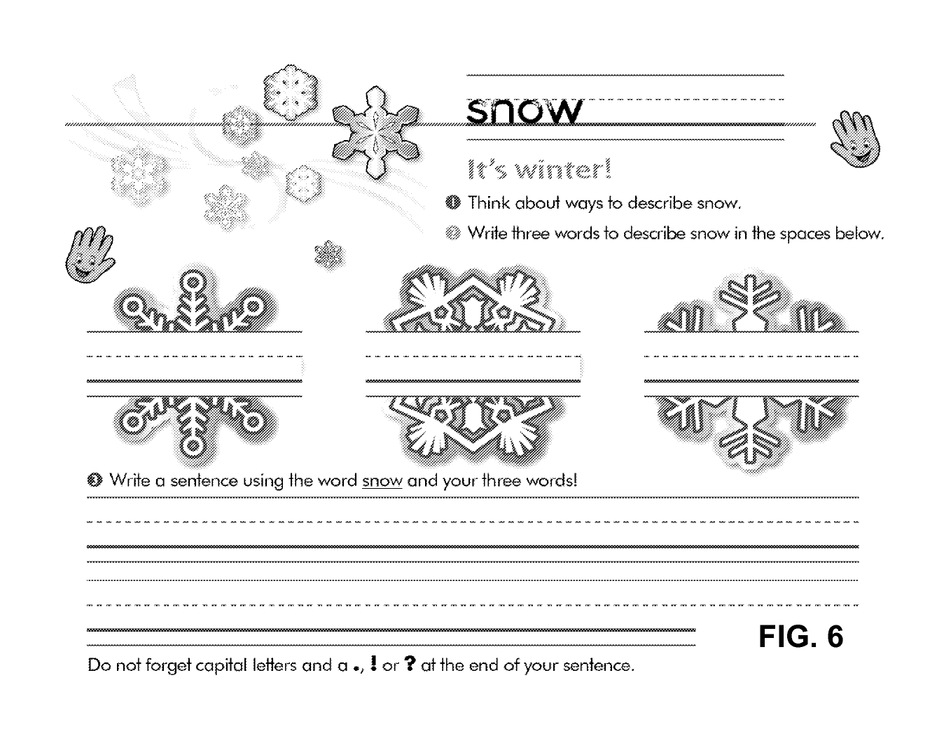

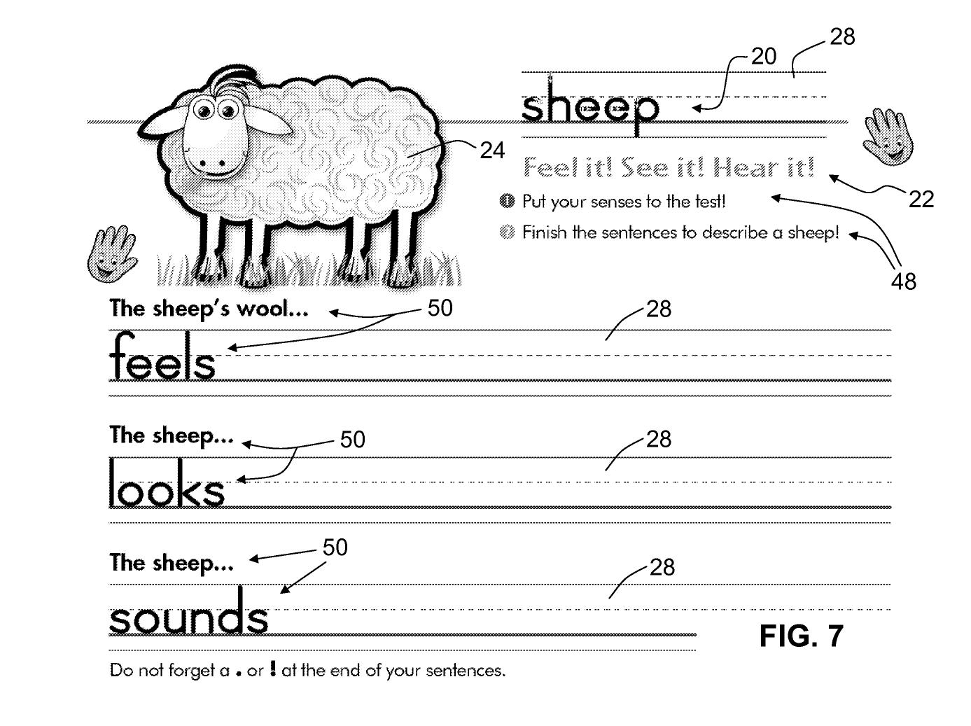

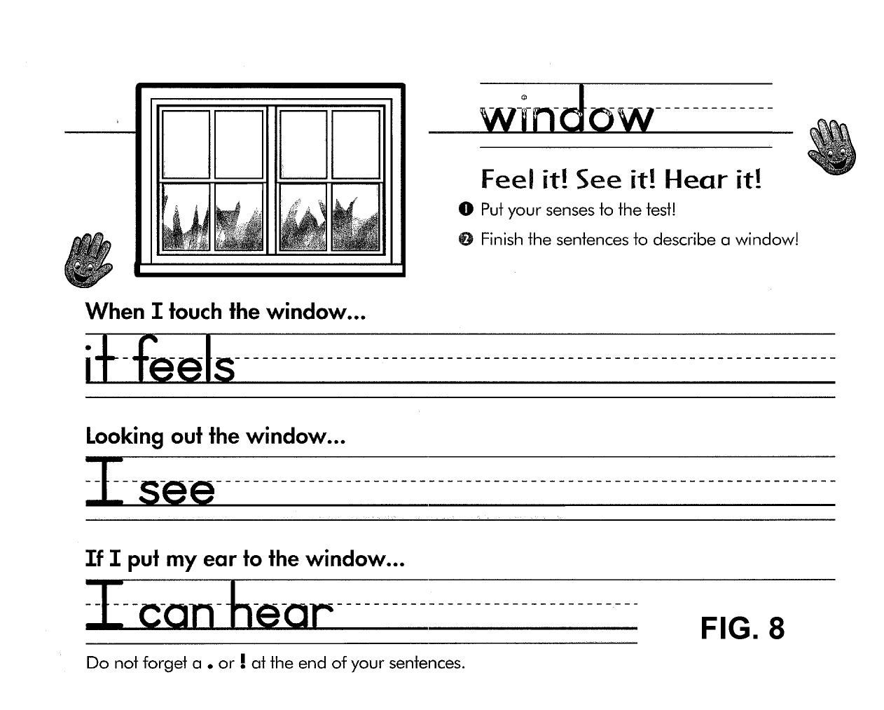

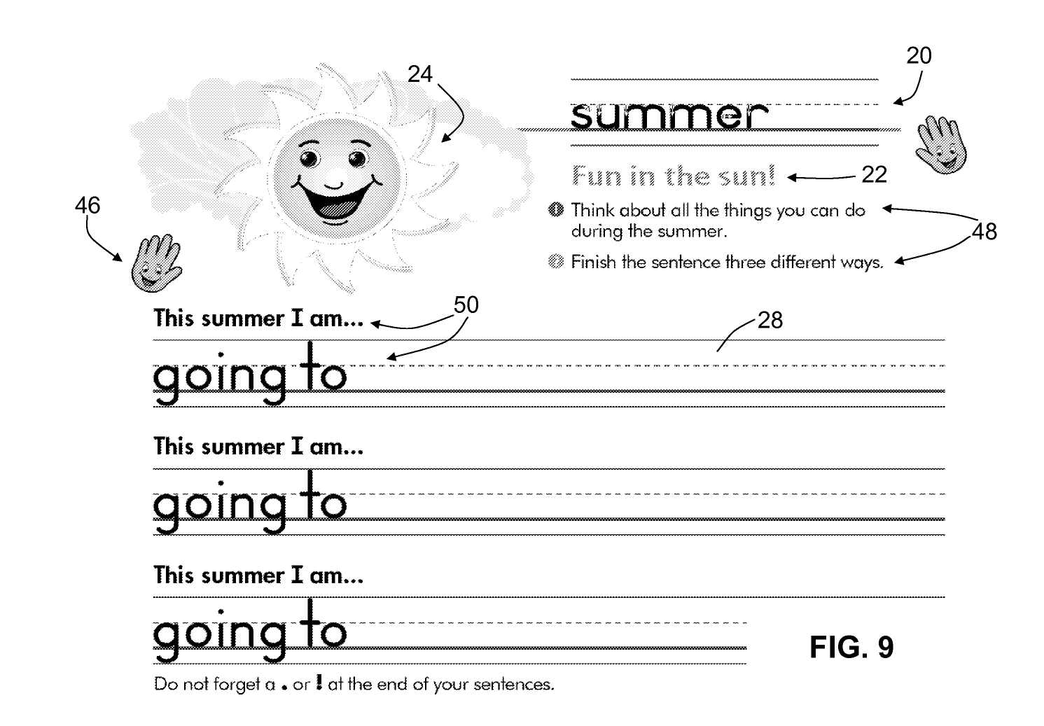

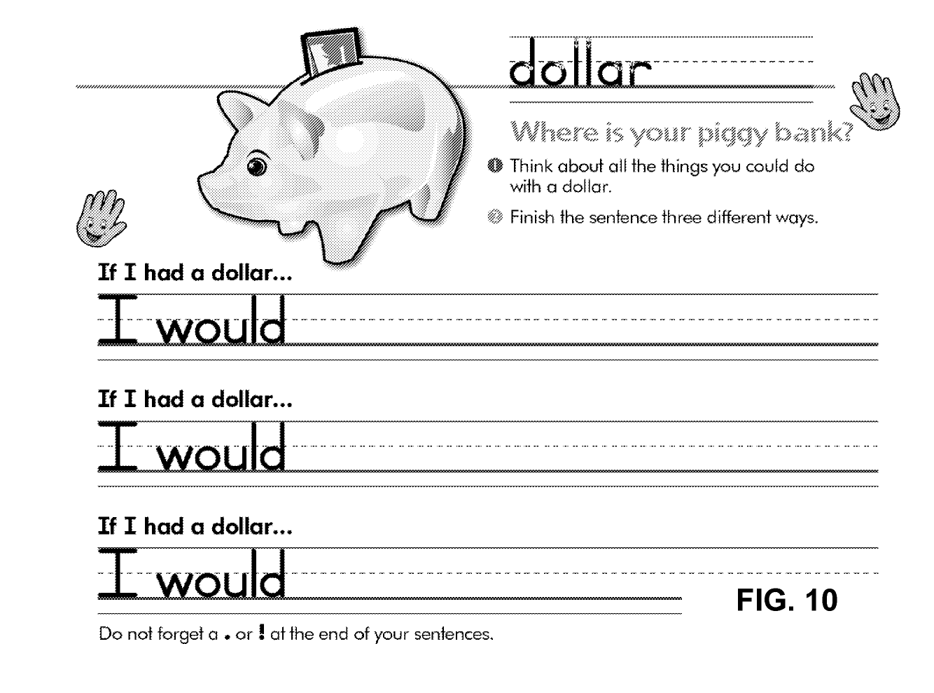

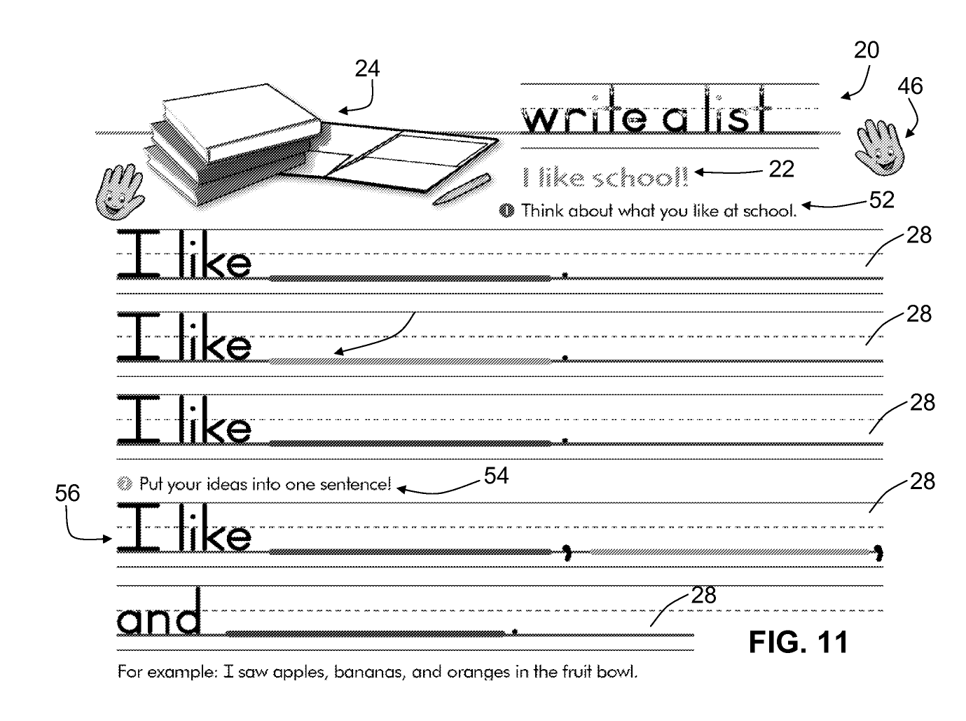

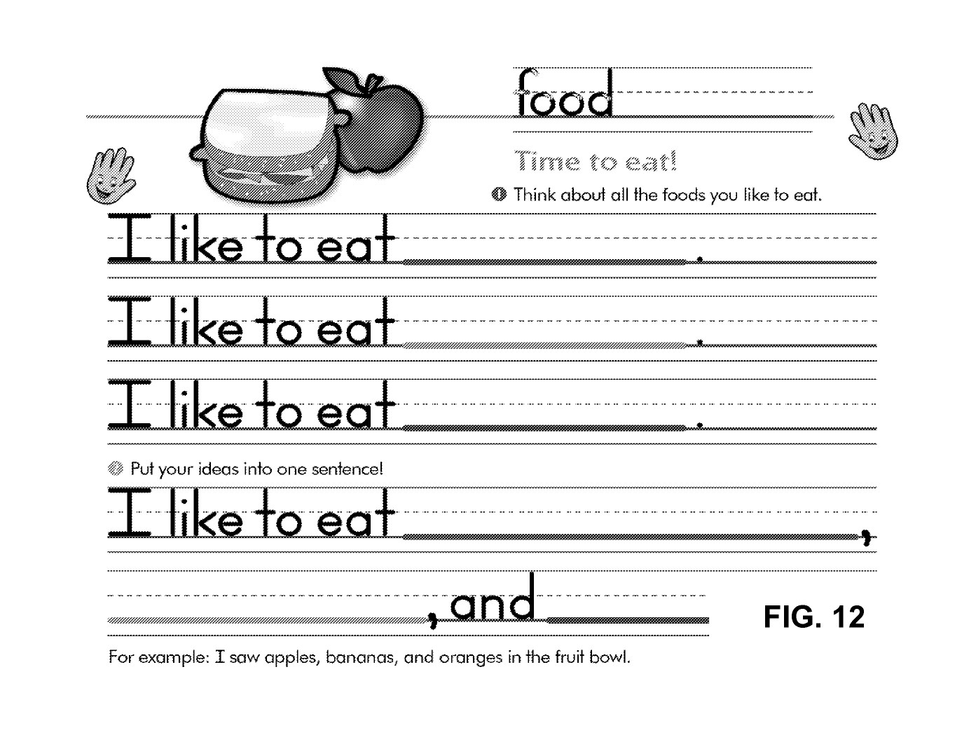

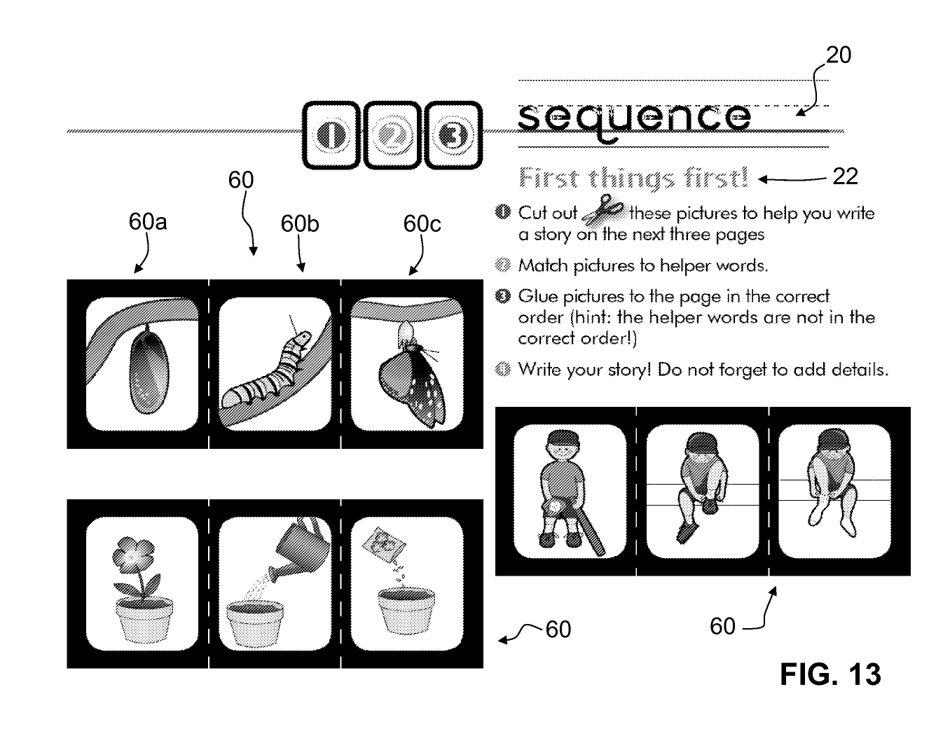

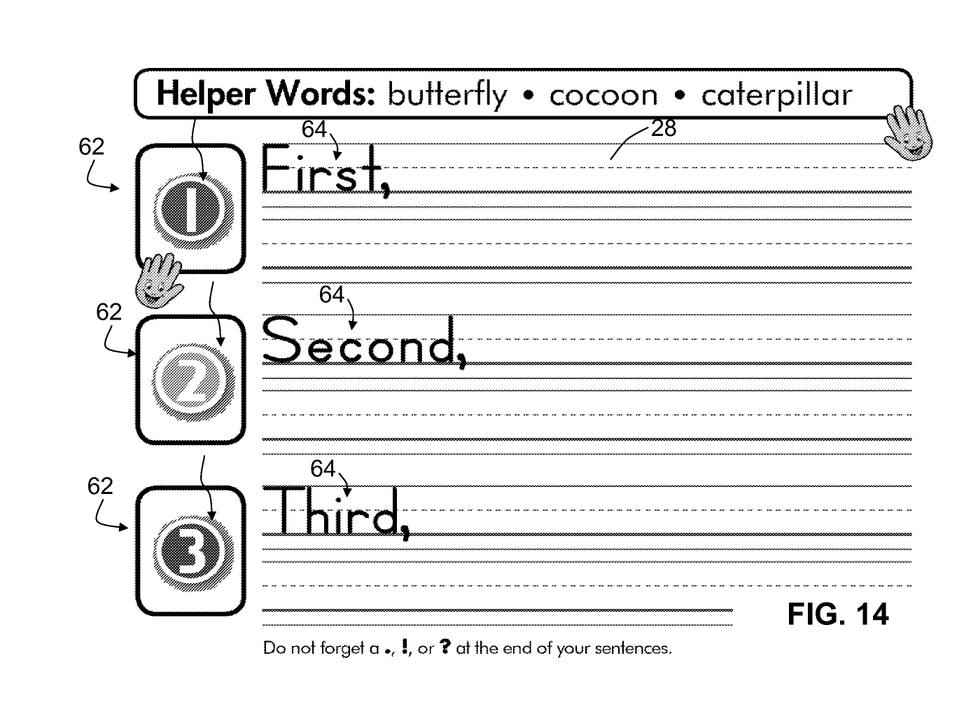

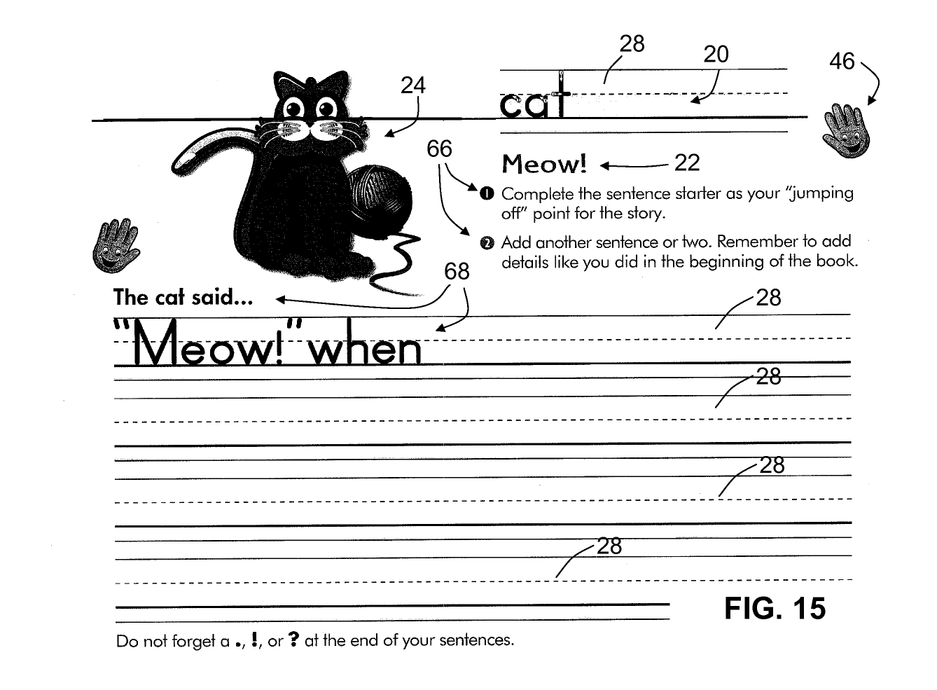

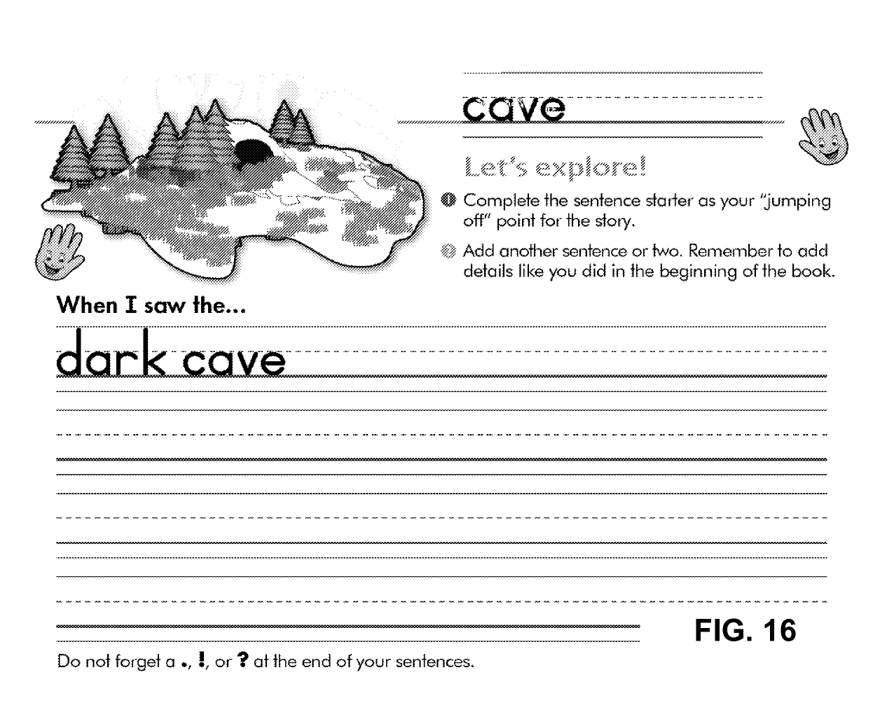

The system of the present invention may include various types of instruction sheets arranged in order of increasing complexity to aid the user in written expression and creative writing skill development. A plurality of each type of instruction sheet, each having varying indicia, may be grouped together to allow the user to develop a single set of skills through repetition of that type of instruction sheet before progressing to the next type of instruction sheets. For example, FIGS. 1 and 2 of the attached drawing sheets are examples of first, primary or basic instruction sheets; FIGS. 3 and 4 are examples of second instruction sheets; FIGS. 5 and 6 are examples of third instruction sheets; FIGS. 7 and 8 are examples of fourth instruction sheets; FIGS. 9 and 10 are examples of fifth instruction sheets; FIGS. 11 and 12 are examples of sixth instruction sheets; FIGS. 13 and 14 are examples of seventh instruction sheets, and FIGS. 15 and 16 are examples of eighth instruction sheets. The instruction sheets may be arranged in order such that the first instruction sheets provide instructions and skill development relating to the simplest and most basic skills, and the eighth instruction sheets provides instructions and skill development relating to the most complex and advanced skills.

A plurality of each type of instruction sheet, each having varying indicia, may be grouped together to allow the user to develop a single set of skills through repetition of that type of instruction sheet before progressing to the next type of instruction sheets. The system shown herein shows only two illustrative sheets in each set of instruction sheets, although the number of sheets in each set can be more, or less, than two sheets, as desired. Further alternately, various types of instructions may be combined on a single sheet. Each sheet may be 8.5″×11″ at least for one embodiment.

Each instruction sheet may include a sheet-like material or body. The sheets/sheet-like body can be made of from any of a wide variety of materials but may typically be made of a cellulose-based or pulp-based paper such that the sheets are generally water absorbent and can be written upon by a wide variety of media (i.e. pens, pencils, markers, crayons, etc.) However, the sheets can be made of any of a relatively wide variety of materials, and need not necessarily be of a water-absorbent material. For example, the sheets/sheet like-body could be a made of a write-on/wipe off (polymer) material that can be re-used in the manner of white board, etc. The instruction sheets may be relatively thin, and may have a thickness of about 0.5 mm or less.

The first set of instruction sheets may be a starting point for story development skills, and may also be termed “list-generating (noun)” instruction sheets. In particular, each sheet in the first set may include a theme and title 20 which may describe or elaborate upon the theme. For example, the title/theme 20 of the instruction sheet on FIG. 1 is “classroom.” Below the title 20, encouragement indicia 22 may be provided. The encouragement indicia 22 may take the form of text or indicia that elaborates upon the theme/title 20 of that sheet and provides further enthusiasm and inspiration to the user (i.e., “It's a school day!”).

Each sheet in the first set of instruction sheets may also include a picture, drawing or other visual representation 24 associated with the theme (i.e., in the sheet of FIG. 1, a drawing of a blackboard, a table and an apple). Each sheet may include sequentially numbered instructions or instruction indicia 26 that provide background information to the user and encourage the user to imagine the setting and generate a list of nouns related to the theme or category. For example, in the example of the instruction sheet of FIG. 1, a user is encouraged to pretend he or she is a teacher, and to write six items that may be found in a classroom. The user may be cued to write a number of items (six items, in this case) greater than the number of items in the visual representation 24 (three items, in this case) to ensure the user does not simply list the items shown in the visual representation 24. The user is cued to write the six items in the six writing spaces 28 below.

The writing spaces 28 may be provided such that the user can write the identified items thereon. Each writing space 28 may include a baseline 30 and an ascender line 32 positioned above the baseline 30, and a descender line 34 positioned below the baseline 30. An intermediate line 36 (a dotted line in the illustrated embodiment) may be positioned between the baseline 30 and the ascender line 32. The lines 30, 32, 34, 36 are provided to guide the user in his or her writing thereon.

The differing spaces defined by the baseline 30, ascender line 32, descender line 34 and intermediate line 36 may be colored or shaded to guide letter formation and alignment. In particular, the lower portion 38 of the writing space 28 (positioned between the baseline 30 and descender line 34) may be colored brown (representing dirt or earth), the middle portion 40 (positioned between the baseline 30 and the intermediate line 36) may be colored green (representing plants or vegetation, such as grass), and the upper portion 42 (positioned between the intermediate line 36 and the ascender line 32) may be colored blue (representing sky).

In this manner, the colored portions 38, 40, 42 provide vertical orientation within each writing space 28 that is intuitive and universally understood since the sky is above vegetation, which is in turn above soil. The use of brown, green and blue colors also presents a brightly colored sheet to attract and retain the attention of the user. The writing spaces 28 also encourage a user to write neatly while generating ideas and subsequently writing the ideas on paper, which results in increased writing fluency. The use of coloring in the writing spaces 28 is described in more detail in U.S. patent application Ser. No. 11/853,988, entitled COLOR CODED LETTER GUIDE, filed on Sep. 12, 2007, the entire contents of which are hereby incorporated by reference.

The title 20 of each instruction sheet may be written on a color-coded writing space 28. The letters of the title 20 may be written with sequential guide arrows and numbers 44 embedded in the letters of the title 20 to reinforce proper letter formation. Moreover, each instruction sheet may include or carry thereon at least one hand cue 46 upon which a user can place his or her hand and manually stabilize the associated instruction sheet. Further detail relating to the hand cues is provided in U.S. patent application Ser. No. 11/853,988.

Various primary instruction sheets, which encourage a user to list various items, places, people or the like may be provided so that the user becomes familiar with the concept of generating lists related to a theme. The primary instruction sheets thereby introduce categorical thought flow, and teach a user how to ideate and visualize setting with respect to people, places or things (nouns) found in that setting. For another example, as shown on FIG. 2, the title/theme of the instruction sheet is “animal farm.” The encouragement indicia may take the form of text or indicia that elaborates upon the theme/title of that sheet and provides further enthusiasm and inspiration to the user (i.e., “Moo! Oink! Cock-a-doodle-do!”). The sheet may also include a picture, drawing or other visual representation associated with the theme (i.e., a drawing of a cow). The sheet may include sequentially numbered instructions or instruction indicia, for example a user may be asked what animals live on a farm, and to write six farm animals in the six writing spaces below.

After working through the primary instruction sheets, a user may then advance to the second set of instruction sheets, which may be termed “list-generating (descriptive)” instruction sheets. The second instruction sheets (examples of which are shown in FIGS. 3 and 4) are similar to the primary instruction sheets. In particular, each of the second instruction sheets includes a theme or title 20, encouragement text 22 and illustrative indicia 24 in generally the same manner as the primary instruction sheets. However, in this case the instruction indicia 26 of the second instruction sheets encourages a user to write a word or words that describe the item/setting/theme for that sheet. Thus the second instruction sheets introduce categorical thought flow, and teach a user how to ideate and visualize an item with respect to descriptive terms (adjectives) in that setting. Each second instruction sheet may include a hint to encourage a user to use his or her senses in coming up with the descriptive terms. The user is then cued to write the six descriptive terms on the six writing spaces 28 below.

For example, as seen in FIG. 3, the theme or title 20 may be “submarine,” the encouragement text 22 “Dive down deep!” and the instruction indicia 26 instructing the user to pretend to be in a submarine, and ask what words would be used to describe the ocean. The instruction indicia 26 may include a hint to help the user get started. The illustrative indicia 24 may be a picture of a submarine.

For another example, as seen in FIG. 4, the theme or title may be “spider,” the encouragement text “Creepy crawly!” and the instruction indicia instructing the user to imagine a spider crawling around, and ask what words would be used to describe the spider. The illustrative indicia may be a picture of a spider.

The third set of instruction sheets build upon the ideas of the first and second instruction sheets, and but progress to instruct the user to write a sentence utilizing user-generated words (nouns or adjectives). The third set of instruction sheets may be termed “graphic organizer sheets” or “list/sentence instruction sheets.” In particular, as shown on FIG. 5, each of the third instruction sheets includes a theme, title 20, encouragement text 22 and illustrative indicia 24 in generally the same manner as the first and second sets of instruction sheets. However, in this case, the third instruction sheets cue the user to write three nouns and/or adjectives associated with the title/theme. The third instruction sheets include three writing spaces 28, and background illustrative indicia 47 associated with each writing space 28. Each background indicia 47 may also be related to the theme for that sheet. For example, in the third instruction sheet shown on FIG. 5, the background indicia 47 is a wheel, which is associated with the “car” theme 20 of the associated third instruction sheet. Encouragement text 22 may be “Zoom!” Instruction indicia 26 may instruct the user to think about ways to describe a car, and write three words to describe the car. The illustrative indicia 24 may be a picture of a car.

For another example, as seen in FIG. 6, the theme or title may be “snow,” the encouragement text “It's winter!” and the instruction indicia may instruct the user to think about ways to describe snow, and write three words to describe snow. The illustrative indicia may be a picture of snowflakes.

The third instruction sheets also cue the user to write a sentence using the “car” theme/title (as in FIG. 5), or the “snow” theme/title (as in FIG. 6) and the three user-generated words. Sentence writing space (optionally using the color-coded writing space 28 described above) is provided below the third instruction bullet. The third instruction sheets also include text encouraging proper punctuation at the end of a sentence (i.e., use of a period, exclamation point or question mark), and encouraging the appropriate use of capital letters. The third set of instruction sheets thereby introduces a user to the concept of identifying words or concepts (using skills learned in the first and second sets of sheets), and using those words or concepts in a sentence. The third set of instruction sheets use, or take the form of, a simple graphic organizer to encourage a user to utilize skills developed in the first and second sets of instruction sheets to ideate nouns and adjectives to guide sentence development.

The fourth set of instruction sheets may also be termed sensory sentence starter sheets, examples of which are shown on FIGS. 7 and 8. The fourth set of instruction sheets encourage a user to complete sentences utilizing the user's thoughts about their senses. For example, as shown at FIG. 7, each fourth instruction sheet includes a title/theme 20, encouragement text 22 and illustrative indicia 24 similar to the first, second and third sets of instruction sheets. Each fourth instruction sheet further includes text/indicia 48 encouraging a user to utilize his or her senses, and finish sentences on the color-coded writing spaces 28 relating to the title/theme. As in the example of FIG. 7, the title/theme 20 may be “sheep,” and the encouragement text 22 “Feel it! See it! Hear it!” As in another example of FIG. 8, the title/theme may be “window,” and the encouragement text “Feel it! See it! Hear it!”

One or more sentence starters 50 (i.e., a beginning/pre-printed portion of a sentence) may be provided on the sheet to cue the user to write one or more sentences. Each sentence starter 50 relates to the theme/title of that sheet, and includes an adjective relating to one of the user's senses (i.e., touch, taste, hearing, smell, sight). Thus the fourth instruction sheets teach a user to develop abstract thoughts and ideas about the user's senses into concrete terms and phrases without first generating a list of terms on paper, which is a step beyond use of the third instruction sheets (graphic organizers). For example, for FIG. 7, sentence starters 50 may include “The sheep's wool . . . ”, “The sheep . . . ”, and “The sheep . . . ”. For FIG. 8, sentence starters may include “When I touch the window . . . ”, “Looking out the window . . . ”, and “If I put my ear to the window . . . ”

The fourth instruction sheets also include text encouraging proper punctuation at the end of a sentence and appropriate capitalization. The fourth instruction sheets thereby teach a user how to introspectively identify descriptive terms and then use the descriptive terms to complete a sentence.

The fifth set of instruction sheets may also be termed free association sentence starter sheet, examples of which are shown on FIGS. 9 and 10. The fifth set of instruction sheets are similar to the fourth set of instruction sheets. For example, as shown at FIG. 9, each fifth instruction sheet includes a title/theme 20, encouragement text 22 and illustrative indicia 24 similar to the fourth sets of instruction sheets. Each fifth instruction sheet further includes text/indicia 48 encouraging a user describe things that the user wants to do, is going to do, describe hypotheticals and otherwise explain the user's thoughts and feelings. The user is then cued by sentence starters 50 to finish sentences on the color-coded writing spaces 28 relating to the title/theme. The fifth instruction sheets thereby teach a user how to introspectively identify abstract ideas, thoughts, feelings, etc. and then use the identified concepts to complete a sentence. For example, as in FIG. 9, the title/theme may be “summer,” the encouragement text 22 “Fun in the sun!” and the text/indicia 48 instructing the user to think about things that can be done in the summer, and to finish a sentence in three different ways. A sentence starter 50 may be provided, such as “This summer I am . . . ” For another example, as in FIG. 10, the title/theme may be “dollar,” the encouragement text “Where is your piggy bank?” and the text/indicia instructing the user to think about things that can be done with a dollar, and to finish a sentence in three different ways. A sentence starter may be provided, such as “If I had a dollar . . . ”

The sixth set of instruction sheets may also be termed basic sentence sheets, examples of which are shown on FIGS. 11 and 12. Each sheet includes a title/theme 20, encouragement indicia 22 and illustrative indicia 24, and similar to the previous sets of instruction sheets. The sixth set of sheets also includes instruction indica 52 encouraging a user to think about the theme/title for that sheet so that the user can write three associated words or concepts on the color-coded writing spaces 28 below. Each sheet also includes further instruction indicia 54 encouraging a user to then list all three words or concepts in a single sentence. A sentence starter 56 is provided to cue the user. Each of the sixth instruction sheets may include an example of a sentence at the bottom thereof. For example, in FIG. 11 the title/theme 20 may be “write a list,” the encouragement indicia 22 “I like school!” and the instruction indicia 54 “Think about what you like at school.” For another example, in FIG. 12 the title/theme may be “food,” the encouragement indicia “Time to eat!” and the instruction indicia “Think about all the foods you like to eat.”

The sixth set of instruction sheets thus develop the user's thought completion skills. In particular, the sixth set of instruction sheets cue a user to complete a thought in multiple ways (three ways in the illustrated embodiment). The user is then cued to integrate multiple individual sentences into a single sentence in the form of a list sentence, with the introduction of comma use.

The seventh set of instruction sheets may also be termed sequence instruction sheets, and may include an illustration sheet (FIG. 13) and associated sequencing sheets (an example of which is in FIG. 14). The illustration sheet includes a title 20 (i.e., “sequence” in the illustrated embodiment), and encouragement text 22 (i.e., “first things first!” in the illustrated embodiment). The illustration sheet includes various sets (three sets in the illustrated embodiment) of pictures 60, drawings or illustrations relating to a particular sequence of events. For example, one set of illustrations 60 includes a cocoon 60a, a caterpillar 60b and a butterfly 60c. The instruction indicia on the illustration sheet encourages a user to cut out the drawings 60, secure the cut drawings to the pages in the correct order, and write a three sentence story relating to the sequenced drawings.

For example, FIG. 14 illustrates a sequencing sheet including numbered rectangles 62 of a size and shape generally matching of the drawings 60a, 60b, 60c to be cut out from the illustration sheet of FIG. 13. The user is thereby cued to glue or otherwise attach the drawings 60a, 60b, 60c in sequential order on the sequencing sheet. Color-coded writing spaces 28 are positioned adjacent to each numbered rectangle 62, and the user is cued to write text in the writing space associated with each picture. Sequential text 64 is pre-printed on each writing space 28 adjacent to the associated numbered rectangle 62 to provide a cue to the user. For example, the word “first” is positioned next to the number one, the word “second” is positioned next to the number two, and the word “third” is positioned next to the number three. “Helper” words, which describe or otherwise relate to the concept shown in the associated drawings (such as “butterfly,” “cocoon,” and “caterpillar), may be positioned across the top of each sequencing sheet. The helper words are not necessarily arranged in any particular order and thus are not necessarily provided to cue the user's sequencing. Instead the helper words may be provided to simply introduce the user to words that relate to the concepts of that sheet, but which may be words that are not necessarily easily spelled or recognized by a user of the targeted age.

In this manner, the drawings 60a, 60b, 60c can be cut from the illustration sheet and positioned on the sequencing sheet in order (in the illustrated embodiment, drawing 60a should be positioned first, followed by drawing 60c, followed in turn by drawing 60b). A user can then review the helper words and write text associated with each drawing in the proper order as cued by the sequential text 64 (such as the terms “first,” “second,” or “third”) Other sequencing sheets (not shown) may also be used in association with the other drawings 60 on the illustration sheet. In this manner, the seventh set of instruction sheets teach a user how to place ideas or concepts in order by physically arranging the “ideas” in order on each sequencing sheet. The user is then cued to write a sentence with cues relating to the sequential order of the ideas. The seventh set of instruction sheets thereby teaches a user to write a three story sequence with visual cues to guide the sequencing.

The eighth set of instruction sheets may also be termed story starter sheets, examples of which are shown on FIGS. 15 and 16. Each sheet has a title/theme 20 (such as “cat” or “cave”), encouragement indicia 22 (such as “Meow!” or “Let's explore!”) and illustrative indicia 24. Each instruction sheet in the eighth set of instruction sheets also includes instruction indicia 66 that encourage the user to complete a sentence in the color-coded writing space 28, and to add another sentence or two. The user is also encouraged to add details as taught by the other sets of instruction sheets.

For example, each instruction sheet in the eighth set may include the sentence starter 68 that relates to the theme or title of that sheet, thereby encouraging the user to complete the sentence and add other sentences (such as “The cat said . . . ” or “When I saw the . . . ”). The last part of the sentence starter 68 is positioned on the writing space 28 to encourage a user to continue writing on the writing space 28. Because the user has been cued in the previous sets of instructions sheets to identify related concepts and ideas, arrange the concepts or ideas in sequential order, implement thought completion and write a sentence or sentences related to the conceptual ideas, the user is encouraged to implement all the identification and organization concepts taught in the first through seventh sets of instruction sheets when using the eighth set of instruction sheets, and without first generating a list on paper.

If desired, the various sets of instruction sheets may be grouped together and bound in a single booklet/guide. Moreover, various other features may be provided in such a booklet, or otherwise utilized with the sets of instruction sheets. For example, a congratulatory certificate may be included to allow the user to achieve a sense of accomplishment upon completing the booklet. A sheet including various sight words that may help a user during sentence creation may be included. Each sight word may have numbered, sequential arrows to guide a user in the letter formation. Another sheet may be included and have writing spaces for a user to write his or her own word list to develop commonly used words, or words that the instructor/parent believes would be useful to the user. The sight word list and/or individual word list may be attached to the binding mechanism along a perforated line to allow those lists to be separated from the binding mechanism and used by the user when working though the remainder of the guide.

Another sheet which reinforces capital letter writing skills using guide indicia and numbered, sequential arrows as disclosed in, for example, U.S. patent application Ser. No. 11/853,411, entitled LETTER GUIDE SHEET, filed Sep. 11, 2007, the entire contents of which are hereby incorporated by reference, may be provided as part of the guide. Another sheet which operates as a guide sheet for reinforcing proper writing strokes for lower case letters, using the concepts disclosed in U.S. patent application Ser. No. 11/853,988, may also be provided. In this manner, a single guide may provide various tools for developing writing skills, as well as idea identification, sequencing, organization and expression to encourage a user to develop written expression skills and basic grammar skills.

Having described the invention in detail and by reference to the various embodiments, it should be understood that modifications and variations thereof are possible without departing from the scope of the invention.

What is claimed is:

1. A written expression development system comprising:
a list generating instruction sheet having a theme and indicia cuing a user to ideate a list of words related to the theme or category of the list generating instruction sheet;
a list/sentence instruction sheet having a theme, indicia cuing a user to create a list of words related to the theme of the list/sentence instruction sheet, and indicia cuing a user to write or complete a sentence using the list of words created on the list/sentence instruction sheet; and
a sentence starter sheet having a theme, and indicia cuing a user to write or complete a sentence relating to the theme of the sentence starter instruction sheet, wherein the sentence starter instruction sheet does not include indicia cuing a user to create a list of words.

2. The system of claim 1 wherein the list generating instruction sheet cues a user to ideate a list of nouns.

3. The system of claim 1 wherein the list generating instruction sheet cues a user to ideate a list of adjectives.

4. The system of claim 1 wherein the sentence starter sheet cues a user to complete a sentence using sensory descriptive terms.

5. The system of claim 1 wherein the sentence starter sheet cues a user to complete a sentence using terms relating to the user's thoughts and feelings.

6. The system of claim 1 wherein the sentence starter sheet has the beginning of a sentence pre-printed thereon.

7. The written expression development system of claim 1 further comprising a basic sentence instruction sheet having a theme, indicia cuing a user to complete the same sentence starter in a variety of ways, and indicia cuing a user to combine the user-generated sentence completions to write or complete a single list sentence.

8. The written expression development system of claim 1 further comprising a sequence set of instruction sheets including an illustration sheet and a sequencing sheet, the illustration sheet having a plurality of illustrations printed thereon having an inherent sequencing order, the sequencing sheet having spaces upon which the illustrations can be adhered after being separated from the illustration sheet, the sequence set of instruction sheets having indicia cuing a user to write or complete, on the sequencing sheet, a sentence relating to the plurality of drawings.

9. The written expression development system of claim 1 further comprising a story starter instruction sheet having a theme, and indicia cuing a user to write or complete a sentence relating to the theme of the story starter instruction sheet, the story starter instruction sheet lacking any indicia cuing a user to list words.

10. A written expression development system comprising a plurality of instruction sheets arranged in order of increasing complexity, wherein the system includes indicia teaching a user how to visualize and record ideas, organize ideas in writing, and write organized sentences utilizing identified ideas.
